(19) United States
(12) Patent Application Publication
(10) Pub. No.: US 2015/0017415 A1
(43) Pub. Date: Jan. 15, 2015

(54) LIQUID CRYSTALLINE ASSEMBLY OF METAL NANOWIRES IN FILMS

(71) Applicant: Carestream Health, Inc., Rochester, NY (US)

(72) Inventor: David R. Whitcomb, Rochester, NY (US)

(21) Appl. No.: 14/301,406

(22) Filed: Jun. 11, 2014

Related U.S. Application Data
(60) Provisional application No. 61/845,401, filed on Jul. 12, 2013.

(51) Int. Cl. G02B 5/30

(52) U.S. Cl. CPC G02B 5/3016
USPC 428/292.1; 427/162; 427/532

(57) ABSTRACT

Films, such as a film comprising a substrate comprising a substrate surface, and a layer comprising a plurality of nanowires on the substrate, where the plurality of nanowires are aligned substantially normal to the substrate surface. Methods, such as a method comprising depositing a plurality of nanostructures in a fluid onto a substrate comprising a surface, where the deposited nanostructures are aligned substantially normal to the surface of the substrate.

### CROSS REFERENCE TO RELATED APPLICATIONS

This application claims the benefit of U.S. Provisional Patent Application No. 61/845,401, filed Jul. 12, 2013, entitled “LIQUID CRYSTALLINE ASSEMBLY OF METAL NANOWIRES IN FILMS,” which is hereby incorporated by reference in its entirety.

### BACKGROUND

Silver nanoparticles prepared with citrate reduction of Ag⁺ have been known for over 100 years, M. C. Lea, J. Am. Sci., 1889, 37, 476. Under the right conditions, in the presence of capping agents, specific silver nanowire morphologies can be produced. S. E. Skrabalak; Wiley, B J; Kim, M; Formo, E V; Xia, Y, Nano Letters, 2008, 8(7), 2077-81, Silvert P-Y, et al., J. Mater. Chem. 1997, 7, 293-9, and Silvert P-Y, et al., J. Mater. Chem., 1996, 6, 573-7. Silver nanowires have been reported to be able to form liquid crystalline phases. S. Murali, T. Xu, B. D. Marshall, M. J. Kayatin, K. Pizarro, V. K. Radhakrishnan, D. Nepal, V. A. Davis, Langmuir, 2010, 26(13), 11176-11183.

Alkanethiol self-assembled monolayers have been applied to the surface of silver nanowires. P. Andrew, A. Ilie, J. Phys. Conf. Series, 2007, 61, 36. Benzenethiol has been used to provide corrosion protection to silver nanowires. H. Qi, D. Alexson, O. Glembocki, S. M. Prokes, Nanotechnology, 2010, 21, 215705. Aqueous suspensions of binary self-assembled monolayer mixtures have been used to modify the surface of nanoparticles. A. Stewart, S.

Zheng, M. R. McCourt, S. E. J. Bell, ACS Nano, 2012, 6(5), 3718. 3-Aininopropyltriethoxysilane has been used to modify the surface of nanowires. Y-H Uy, C-C Ma, C-C Teng, Y-L Huang, S-H Lee, I. Wang, M-H Wei, Materials Chemistry & Physics, 2012, 1-7.

U.S. Pat. No. 3,653,741 to Marks discloses apparatuses comprising orientable particles and methods of orienting these particles by applying a force field. U.S. Patent Application Publication 2009/0052029 to Dai et al. discloses apparatuses comprising orientable silver nanowires and methods of orienting these nanowires by applying a flow-induced shear force. Korean Patent KR1207403B1 discloses a composition comprising silver nanowires.

### SUMMARY

An optical film may be formed by depositing a layer of nanowires onto a substrate surface. The nanowires may assume organized orientations. We have discovered compositions, methods, and devices incorporating films comprising nanowires oriented substantially normal to the surface of the substrate on which the nanowires are deposited.

In some embodiments, a film is provided comprising a substrate comprising a substrate surface, and a layer comprising a plurality of nanowires on the substrate surface, wherein the plurality of nanowires is aligned substantially normal to the substrate surface.

In some embodiments, each of the nanowires comprises a nanowire surface, wherein at least one surface modifier is disposed on the nanowire surface.

In some embodiments, the at least one surface modifier comprises a chiral molecule. In any of the above embodiments, the nanowires are substantially parallel to each other.

In some embodiments, a method is provided comprising depositing a plurality of nanostructures in a fluid onto a surface of a substrate, wherein the deposited nanostructures are aligned substantially normal to the surface of the substrate. In some embodiments, the plurality of nanostructures comprises a surface-modified nanostructure. In some embodiments, the surface-modified nanostructure comprises a chiral molecule. In some embodiments, the deposited nanostructures are substantially parallel to each other.

In some embodiments, a system is provided comprising a film comprising a substrate comprising a surface, and a layer comprising a first group of nanowires and a second group of nanowires, wherein each of the nanowires in the first group of nanowires and the second group of nanowires is aligned along a principle axis, the principle axis being substantially normal to the surface of the substrate, a method of orienting nanowires, the method comprising applying a stimulus received by the second group of nanowires, wherein, after the second group of nanowires receives the stimulus, the second group of nanowires is aligned at an angle between about 0 degrees and about 90 degrees to the principle axis. In some embodiments, the method further comprises receiving a light beam by the substrate. At least another embodiment provides a method comprising providing a film comprising a substrate and at least one first layer disposed on the substrate, where the substrate comprises at least one first surface, where the at least one first layer comprises at least a first group of nanowires and a second group of nanowires, where the first group of nanowires and the second group of nanowires are substantially aligned with a principle axis substantially normal to the at least one first surface; and applying at least one stimulus to the at least one second group of nanowires, where after application of the at least one stimulus, the second group of nanowires is aligned at an angle between about 0 degrees and about 90 degrees to the principle axis. In such a method, the at least one stimulus may be directly or indirectly applied to the at least one second group of nanowires. At least some such methods further comprise passing a light beam through the at least one first layer to the substrate. In some cases, the film may further comprise at least one second layer disposed between the at least one first layer and the substrate.

These embodiments and other variations and modifications may be better understood from the description of the figures, description, exemplary embodiments, examples, claims, and figures that follow. Any embodiments provided are given only by way of illustrative example. Other desirable objectives and advantages inherently achieved may occur or become apparent to those skilled in the art. The invention is defined by the attached claims.

### DESCRIPTION OF FIGURES

FIG. 1 shows an optical film comprising oriented nanowires.

FIG. 2 shows an optical film affected by a light beam.

FIG. 3 shows isolated nanowires.

FIG. 4 shows aggregated nanowires.

FIG. 5 shows nanowires in a mesostructure.

### DESCRIPTION

All publications, patents, and patent documents referred to in this document are incorporated by reference herein in their entirety, as though individually incorporated by reference.

U.S. Provisional Patent Application No. 61/842,405, filed Jul. 3, 2013, entitled “SURFACE MODIFICATION OF METAL NANOSTRUCTURES,” is hereby incorporated by reference in its entirety. US patent application publication 2012/0148844, entitled “NANOWIRE PREPARATION METHODS, COMPOSITIONS, AND ARTICLES,” is hereby incorporated by reference in its entirety. U.S. Provisional Patent Application No. 61/845,401, filed Jul. 12, 2013, entitled “LIQUID CRYSTALLINE ASSEMBLY OF METAL NANOWIRES IN FILMS,” which is hereby incorporated by reference in its entirety.

### Introduction

Silver nanowires can be induced to assemble in a liquid crystalline phase. When a fluid comprising silver nanowires is deposited onto a substrate, the silver nanowires typically assume random orientations. In some applications, it may be desirable that deposited silver nanowires assemble into an organized phase. We have discovered methods and compositions that facilitate the orientation of deposited silver nanowires onto a substrate to positions that are substantially normal to the surface of the substrate.

Films comprising such oriented silver nanowires may be used in image displays, electronics, and telecommunication devices. Image displays may include, without limitation, liquid crystal displays (LCD), plasma display panels (PDP), and organic EL viewing displays.

### Nanostructures

Nanostructures may be any structure, groups of structures, particulate molecule, and groups of particulate molecules of potentially varied geometric shape with the shortest dimension sized between 1 nm and 100 nm. In some embodiments, the nanostructures may be metal nanostructures, such as, for example, metal meshes or metal nanowires, including silver nanowires. Other non-limiting examples of nanostructures include carbon nanotubes, transparent conductive oxide, and graphene.

In some embodiments, nanowires may assemble in a liquid crystalline phase formation. The nanowires may be in various liquid crystal phases, also referred to as “mesophases,” based on the ordering of the nanowires in a medium. The nanowires may be in an orientational or directional order, where nanowires are generally pointing in the same direction. The nanowires may be in a positional order, where nanowires are arranged in an ordered lattice, for example, in a translational order, where nanowires have some ordered arrangement in space. Such orders may be either short-range, that is, between nanowires that are close together, or long-range, that is, extending to larger, sometimes macroscopic, dimensions.

In some embodiments, nanowires may align in a directional order, such as, for example, when nanowires are in the nematic phase. In such cases, the nanowires may align with their longitudinal dimension or long axes substantially parallel, and the nanowires may tend to point in the same direction. For the purpose of this application, “substantially parallel” nanowires shall be interpreted to mean nanowires oriented within about 10 degrees, or within about 9 degrees, or within about 8 degrees, or within about 7 degrees, or within about 6 degrees, or within about 5 degrees, or within about 4 degrees, or within about 3 degrees, or within about 2 degrees, or within about 1 degree of each other. Such nanowires may also orient along one or more axis. In some examples, nanowires are uniaxial and may orient along only their long axis. In some examples, nanowires are biaxial and may orient along their long axis and a secondary axis. In some examples, the directional order is long-range.

In some embodiments, nanowires may be positionally ordered, such as, for example, when nanowires are in the smectic phase. Such positional order may be along one direction. In such cases, the nanowires may maintain the orientation order of nematics but may also tend to align themselves in layers or planes.

In some embodiments, nanowires assemble as a liquid crystalline phase in a deposited layer on a substrate. In some examples, the nanowires may orient substantially normal to the surface of the substrate. For the purpose of this application, nanowires “substantially normal” to the surface of the substrate shall be interpreted to mean nanowires oriented within about 10 degrees, or within about 9 degrees, or within about 8 degrees, or within about 7 degrees, or within about 6 degrees, or within about 5 degrees, or within about 4 degrees, or within about 3 degrees, or within about 2 degrees, or within about 1 degree of a normal vector of the surface of the substrate. In some examples, the nanowires may re-orient to being substantially parallel to the surface of the substrate. For the purpose of this application, nanowires “substantially parallel” to the surface of the substrate shall be interpreted to mean nanowires oriented at an angle of between about 80 and about 100 degrees, or between about 81 and about 99 degrees, or between about 82 and about 98 degrees, or between about 83 and about 97 degrees, or between about 84 and about 96 degrees, or between about 85 and about 95 degrees, or between about 86 and about 94 degrees, or between about 87 and about 93 degrees, or between about 88 and about 92 degrees, or between about 89 and about 91 degrees relative to a normal vector of the surface of the substrate.

### Substrates

A substrate may be any material onto which nanowires are deposited. The substrate can be rigid or flexible. The substrate may be optically clear. An optically clear substrate may have a light transmission that is at least 80% as measured in the visible region (i.e. 400 nm-700 nm).

Suitable rigid substrates include without limitation, for example, glass, polycarbonates, acrylics, and the like. A specialty glass such as alkali-free glass (e.g., borosilicate), low alkali glass, and zero-expansion glass-ceramic can be used. The specialty glass may be well-suited for thin panel display systems, including liquid crystal display (LCD).

Suitable flexible substrates include, but are not limited to: polyesters (e.g., polyethylene terephthalate (PET), polyester naphthalate, and polycarbonate), polyolefins (e.g., linear, branched, and cyclic polyolefins), polyvinyls (e.g., polyvinyl chloride, polyvinylidene chloride, polyvinyl acetals, polystyrene, polyacrylates, and the like), cellulose ester bases (e.g., cellulose triacetate, cellulose acetate), polysulphones such as polyethersulphone, polyimides, silicones and other conventional polymeric films.

### Surface Modification

When a fluid comprising nanowires is deposited onto a substrate, the nanowires may be arranged parallel to the surface of the substrate. In some embodiments, a surface modifier may be used to modify the surface characteristics of the nanowires. Such surface modification is described in U.S. Provisional Patent Application No. 61/842,405, filed Jul. 3, 2013, entitled “SURFACE MODIFICATION OF METAL NANOSTRUCTURES,” which is hereby incorporated by reference in its entirety. In further embodiments, the surface modifier may be used to align the nanowires substantially normal to the surface of the substrate. In still further embodiments, the surface modifier may be used to align the nanowires to be substantially parallel with one another.

In such cases, the surface modifier may comprise a nanowire binding component that may bind to the nanowire, a surface modifying component that may modify the surface of the nanowires, and a linkage component that bonds the nanowire binding component and the surface modifying component.

In some embodiments, the surface modifying component comprises a chiral molecule. In some embodiments, the surface modifying component may be an enantiopure compound that has only one chirality or chiral molecule. A chiral molecule is one that has a non-superimposable mirror image. In some embodiments, the chiral molecule may comprise an asymmetric carbon atom. An asymmetric carbon atom is a carbon atom that is attached to four different types of atoms or four different groups of atoms. In some embodiments, the chiral molecule may comprise an amino acid. In such cases, the amino acid may be an enantiomerically pure amino acid that has only one chirality or chiral molecule. In some embodiments, the surface modifying component may comprise an inorganic coordination compound that comprises a chiral molecule. A non-limiting example of an inorganic compound that comprises a chiral molecule is tris(bipyridine)ruthenium(II). In some cases, given that the nanowires may have some tendency to assemble in organized phases, a chiral molecule may affect the spatial arrangement of the nanowires by aligning them substantially parallel to each other and substantially normal to the surface of the substrate. For the purpose of this application, wires that are “substantially parallel” to each other are wires that are oriented within about 10 degrees, or within about 9 degrees, or within about 8 degrees, or within about 7 degrees, or within about 6 degrees, or within about 5 degrees, or within about 4 degrees, or within about 3 degrees, or within about 2 degrees, or within about 1 degree of each other.

In some embodiments, given that a chiral molecule may interact with polarized light, a film may be created with a first group of nanowires surface treated with chiral molecules and a second group of nanowires that is not surface treated with chiral molecules. In such cases, different regions of the film may polarize light differently, which may be useful in liquid crystal displays.

### Methods

The nanowires can be deposited or coated on a substrate. In some embodiments, the surfaces of the nanowires may be modified with a surface modifier, such as one comprising a chiral molecule. In such cases, the chiral molecules on the surfaces of the nanowires may align the nanowires to a direction that is substantially normal to the surface of the substrate. In some embodiments, the alignment of nanowires may occur almost simultaneously during the coating process.

The nanowires may be fixed into their aligned orientations by any type of affinity between the nanowires and the substrate, such as ionic attraction, chemical bonding, hydrophobic interactions, hydrophilic interactions, and the like. The surface of the substrate may comprise functional groups, either inherently or by functionalization, that exhibit affinities for the nanowires. Non-limiting examples of suitable functional groups include thiols, amines, amino acids, carboxylic acids, and the like. In some embodiments, functional groups may be anchored onto the substrate that may tend to bind with the nanowires. Such anchoring may, for example, be performed before depositing the nanowires. The nanowires may have affinity for the substrate. In some embodiments, the nanowires may align and bind with the substrate surface almost simultaneously during deposition. In some embodiments, the surface modifiers may comprise adhesion components that bond the nanowires to the surface of the substrate. In some embodiments, the chiral molecule may also act as an adhesion component that provides the nanowires with the affinity for the substrate. In some embodiments, the surface modifier and substrate or substrate functionalization substances may be selected to yield desired affinities between the nanowires and the substrate. In some embodiments, an adhesion layer can be deposited on the substrate surface to fix the aligned orientation of the nanowires. The adhesion layer may functionalize and modify the substrate surface to facilitate binding between the nanowires and the substrate. In some embodiments, the adhesion layer may be co-deposited with the nanowires. In some embodiments, the adhesion layer may be coated onto the substrate before the depositing the nanowires.

In some embodiments, the nanowires may be deposited by liquid phase coating techniques (e.g. roll coating using a smooth rod). Alignment of nanowires onto a substrate can be affected by factors, such as coating technique and solvent formulation. In some embodiments, a coating technique involving a larger timescale over which shear rate is applied and more uniform shear rate may be used. For example, a layer of nanowires may be formed by a larger diameter rod to apply a coating on a substrate on a draw down table. In some embodiments, a coating may be applied at a uniform shear rate. For example, a smooth rod (as opposed to a wire covered Mayer rod) may be used to apply a coating at a uniform shear rate. In some embodiments, low surface tension organic solvents may be used to deposit a layer of nanowires. Non-limiting examples of organic solvents include isopropyl alcohol, n-butanol, and propylene glycol monomethyl ether. Nanowires may be deposited by using a concentrated suspension of nanowires as a coating fluid or by multiple coating passes using a less concentrated suspension of nanowires. In some embodiments, multiple layers of nanowires are formed on the substrate. These nanowires may align substantially normal to the surface of the substrate or may align in other orientations.

The substrate surface may be subjected to additional treatments to facilitate the deposition, alignment, or immobilization of nanowires onto a substrate. In some embodiments, surface treatment of the substrate may yield better wettability for deposition or better adhesion during immobilization.

### Optical Films

Optical films may be used as part of polarizers, such as absorptive and reflective polarizers, or retarders, such as half wave or quarter wave retarders. These films may be used independently or as part of a matrix and laminate on a substrate or in combination with other films in a multilayer structure.

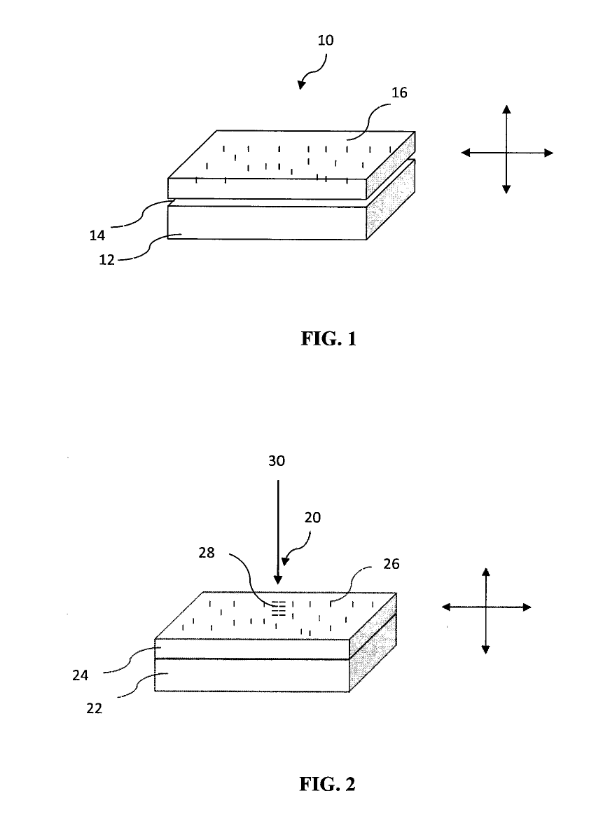

FIG. 1 shows an optical film 10 comprising a substrate 12 and a layer 14 of nanowires 16 deposited onto the substrate 12. The surfaces of the deposited nanowires may be modified with a surface modifier that comprises a chiral molecule. In some embodiments, the nanowires 16 may be substantially normal to the surface of the substrate (as shown). For example, a nanowire may be substantially normal to the surface of the substrate when they are at angle of within 10 degrees (e.g. within 9, 8, 7, 6, 5, 4, 3, 2, 1 degrees) of a vector normal to the surface of the substrate. In this orientation, the lengths of the nanowires are aligned along a direction that is substantially normal to the surface. In such cases, the lengths of the nanowires may be longest dimension of the nanowire. In some embodiments, most of the deposited nanowires are substantially normal to the surface of the substrate. In some embodiments, the deposit may include some non-nanowire nanoparticles. Also shown, the nanowires 16 are substantially parallel to one another. For example, a nanowire may be substantially parallel to one another when they oriented within 10 degrees of each other (e.g. within 9, 8, 7, 6, 5, 4, 3, 2, 1 degrees). In some embodiments, a stimulus, such as an electric field, magnetic field, or force, such as a shear force, may align the nanowires into a position that is substantially normal to the surface of the substrate after deposition.

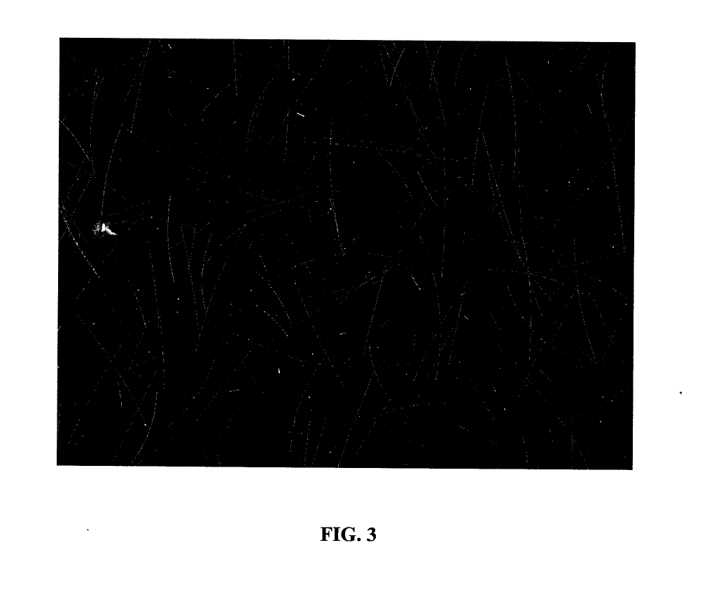

FIG. 2 shows an optical film 20 comprising a substrate 22 and a layer 24 of a first group of nanowires 26 and a second group of nanowires 28 deposited onto the substrate 22. As shown, the nanowires in the first group of nanowires are oriented along a principle axis in which the principle axis is substantially normal to the substrate surface.

In some embodiments, a stimulus 30 may be directed to the second group of nanowires 28. Non-limiting examples of stimuli include electric field, magnetic field, and shear force. FIG. 2 represents the orientation of the second group of nanowires 28 after application of a stimulus. As shown, the stimulus may re-orient the second group of nanowires 28 to a position that is offset at an angle from the principle axis. For example, the nanowires in the second group of nanowires 28 may be offset from the principle axis by any angle greater than 0 degrees and less than or equal to 90 degrees. As shown, in some embodiments, the nanowires in the second group of nanowires 28 are substantially parallel with the substrate surface. In such cases, the nanowires in the second group of nanowires 28 may be offset from the principle axis by approximately 90 degrees. The nanowires in the second group of nanowires 28 may be substantially parallel to the surface of the substrate 22.

In such a case, when a light beam 30 is directed at the substrate, light is blocked from going through the second group of nanowires 28 while light can pass between the nanowires in the first group 26. The nanowires in the first group of nanowires 26 may be oriented along a direction of the light beam. In some embodiments, the light is a polarized light. In such cases, the nanowires in the first group of nanowires 26 may be orient along a polarization direction. For the second group of nanowires 28 to block light, the nanowires in the second group of nanowires 28 may be offset at angle from the direction of the light beam or the polarization direction. In such cases, the nanowires in the second group of nanowires 28 may be offset from the direction of the light beam or the polarization direction by any angle between about 0 degrees and 90 degrees.

### EXEMPLARY EMBODIMENTS

U.S. Provisional Patent Application No. 61/845,401, filed Jul. 12, 2013, entitled “LIQUID CRYSTALLINE ASSEMBLY OF METAL NANOWIRES IN FILMS,” which is hereby incorporated by reference in its entirety, disclosed the following 29 non-limiting exemplary embodiments:

A. A film comprising:

a substrate comprising a substrate surface, and

a layer comprising a plurality of nanowires on the substrate, wherein the plurality of nanowires are aligned substantially normal to the substrate surface.

B. The film of embodiment A, wherein each of the nanowires comprises a nanowire surface, wherein at least one surface modifier is disposed on the nanowire surface.
C. The film of embodiment B, wherein the at least one surface modifier comprises a chiral molecule.
D. The film of embodiment C, wherein the chiral molecule comprises an amino acid.
E. The film of embodiment D, wherein the amino acid is enantiomerically pure.
F. The film of embodiment C, wherein the at least one surface modifier comprises an inorganic coordination compound that comprises a chiral molecule.
G. The film of embodiment F, wherein the inorganic coordination compound comprises tris(bipyridine)ruthenium(II).
H. The film in any of embodiments A-G, wherein the plurality of nanowires are substantially parallel to each other.
J. A method comprising:

depositing a plurality of nanostructures in a fluid onto a substrate comprising a surface, wherein the deposited nanostructures are aligned substantially normal to the surface of the substrate.

K. The method of embodiment J, wherein the plurality of nanostructures comprises a surface-modified nanostructure.
L. The method of embodiment K, wherein the surface-modified nanostructure comprises a chiral molecule.
M. The method of embodiment L, wherein the chiral molecule comprises an amino acid.
N. The method of embodiment M, wherein the amino acid is enantiomerically pure.
P. The method of embodiment L, wherein the at least one surface modifier comprises an inorganic coordination compound that comprises a chiral molecule.
Q. The method of embodiment P, wherein the inorganic coordination compound comprises tris(bipyridine)ruthenium(II).
R. The method of any of embodiments J-Q, wherein the deposited nanostructures are substantially parallel to each other.
S. In a system comprising a film comprising a substrate comprising a surface and a first layer, the first layer comprising a first group of nanowires and a second group of nanowires, wherein each of the nanowires in the first group of nanowires and the second group of nanowires are substantially aligned along a principle axis, the principle axis being substantially normal to the surface of the substrate,

a method of orienting nanowires, the method comprising responding to a stimulus received by the second group of nanowires, wherein, after the second group of nanowires receives the stimulus, the second group of nanowires is aligned at an angle between about 0 degrees and about 90 degrees to the principle axis.

T. The method of embodiment S, further comprising receiving a light beam through the first layer by the substrate.
U. The method of embodiment S, wherein the first layer is disposed on the substrate.
V. The method of embodiment U, wherein the film further comprises at least one second layer disposed between the substrate and the first layer.
W. The method of embodiment S, wherein the first layer is disposed on the surface.
X. The method of embodiment W, wherein the film further comprises at least one second layer disposed between the surface and the first layer.
Y. A method comprising:

providing a film comprising a substrate and at least one first layer disposed on the substrate, the substrate comprising at least one first surface, the at least one first layer comprising at least a first group of nanowires and a second group of nanowires, the first group of nanowires and the second group of nanowires being substantially aligned with a principle axis substantially normal to the at least one first surface; and

applying at least one stimulus to the at least one second group of nanowires,

wherein after application of the at least one stimulus, the second group of nanowires is aligned at an angle between about 0 degrees and about 90 degrees to the principle axis.

Z. The method according to embodiment Y, wherein the at least one stimulus is directly applied to the at least one second group of nanowires.
25. The method according to embodiment Y, wherein the at least one stimulus is indirectly applied to the at least one second group of nanowires.
AA. The method according to embodiment Y, further comprising passing a light beam through the at least one first layer to the substrate.
AB. The method according to embodiment Y, wherein the film further comprises at least one second layer disposed between the at least one first layer and the substrate.
AC. The method according to embodiment Y, wherein the at least one first layer is disposed on the at least one first surface.
AD. The method according to embodiment AC, wherein the film further comprises at least one second layer disposed between the at least one first layer and the at least one first surface.

### EXAMPLES

### Example 1

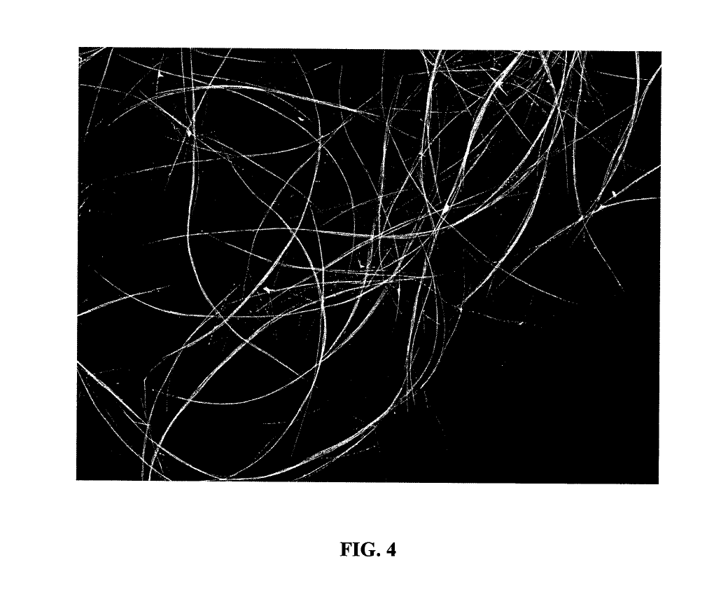

Silver nanowires were prepared according to the materials and methods disclosed in US patent application publication 2012/0148844, entitled “NANOWIRE PREPARATION METHODS, COMPOSITIONS, AND ARTICLES,” which is hereby incorporated by reference in its entirety. The silver nanowires were purified using acetone and isopropyl alcohol (IPA) in a 50/50 ratio by shaking 30 minutes and centrifuging at 300 G for 45 minutes. The solid was dispersed in IPA back to its original volume and collected. In a 100 mL 3-neck flask, 70 mL of the purified silver nanowire mixture was combined with benzoyl peroxide at twice the silver concentration. The mixture was heated to 70° C. for 2 hours with magnetic stirring. FIG. 3 shows a scanning electron micrograph of the silver nanowires before combining the silver nanowire mixture with benzoyl peroxide. FIG. 4 shows a scanning electron micrograph of the silver nanowires after combining the silver nanowire mixture with benzoyl peroxide. FIG. 4 shows aggregation of silver nanowire as contrasted with relatively non-aggregated silver nanowires in FIG. 3.

### Example 2

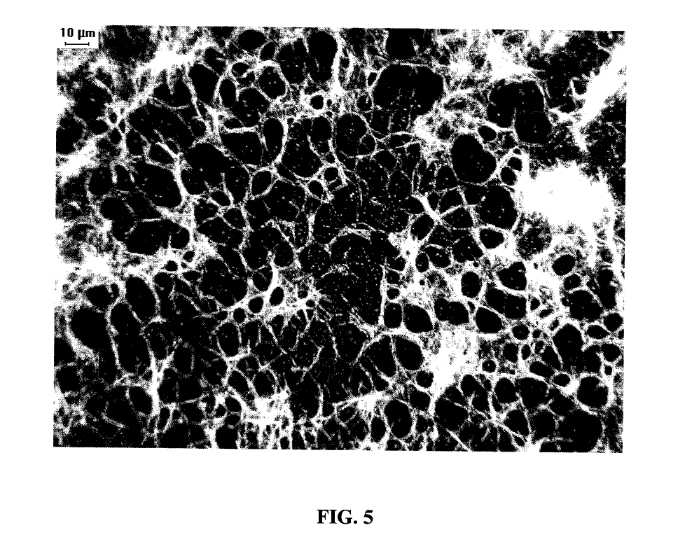

Silver nanowires were prepared according to the materials and methods disclosed in US patent application publication 2012/0148844, entitled “NANOWIRE PREPARATION METHODS, COMPOSITIONS, AND ARTICLES,” which is hereby incorporated by reference in its entirety. The silver nanowires were purified using acetone and isopropyl alcohol (IPA) in a 50/50 ratio by shaking 30 minutes and centrifuging at 300 G for 45 minutes. The solid was dispersed in IPA back to its original volume and collected. In a 100 mL 3-neck flask, 70 mL of the purified silver nanowire mixture was combined with benzoyl peroxide at twice the silver concentration. The mixture was heated to 70° C. for 2 hours with magnetic stirring. FIG. 3 shows a scanning electron micrograph of the silver nanowires before combining the silver nanowire mixture with benzoyl peroxide. FIG. 5 shows a scanning electron micrograph of the silver nanowires after combining the silver nanowire mixture with benzoyl peroxide. FIG. 5 shows aggregation of silver nanowire into a meso-structure as contrasted with relatively non-aggregated nanowires in FIG. 3.

### Example 3 (Prophetic)

Surface modification of silver nanowires is conducted according to the methods of U.S. Provisional Patent Application No. 61/842,405, filed Jul. 3, 2013, entitled “SURFACE MODIFICATION OF METAL NANOSTRUCTURES,” which is hereby incorporated by reference in its entirety. Silver nanowires are prepared and purified to obtain a 4.1 wt % silver nanowire dispersion in isopropanol, which corresponds to 0.032 g silver nanowire per 1 mL of solution. 9.0 mL of isopropanol is added to 1.0 mL of the silver nanowire dispersion and mixed by gentle shaking for 10 minutes. One drop of the chiral molecule is added and mixed by gentle shaking for 2 hours. The mixture is allowed to stand overnight. The mixture is centrifuged the next day at 500 G for 30 min, decanted and redispersed in 0.5 mL isopropanol. The mixture is deposited onto a substrate. A close observation reveals that the nanowires are aligned along a direction in which their lengths are substantially normal to the surface of the substrate.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims and all changes that come within the meaning and range of equivalents thereof are intended to be embraced therein.

What is claimed:

1. A film comprising:
a substrate comprising a substrate surface, and
a layer comprising a plurality of nanowires on the substrate, wherein the plurality of nanowires are aligned substantially normal to the substrate surface.

2. The film of claim 1, wherein each of the nanowires comprises a nanowire surface, wherein at least one surface modifier is disposed on the nanowire surface.

3. The film of claim 2, wherein the at least one surface modifier comprises a chiral molecule.

4. The film of claim 3, wherein the chiral molecule comprises an amino acid.

5. The film of claim 4, wherein the amino acid is enantiomerically pure.

6. The film of claim 3, wherein the at least one surface modifier comprises an inorganic coordination compound that comprises a chiral molecule.

7. The film of claim 6, wherein the inorganic coordination compound comprises tris(bipyridine)ruthenium(II).

8. A method comprising:
depositing a plurality of nanostructures in a fluid onto a substrate
comprising a surface, wherein the deposited nanostructures are
aligned substantially normal to the surface of the substrate.

9. The method of claim 8, wherein the plurality of nanostructures comprises a surface-modified nanostructure.

10. The method of claim 9, wherein the surface-modified nanostructure comprises a chiral molecule.

11. The method of claim 10, wherein the chiral molecule comprises an amino acid.

12. The method of claim 11, wherein the amino acid is enantiomerically pure.

13. The method of claim 12, wherein the at least one surface modifier comprises an inorganic coordination compound that comprises a chiral molecule.

14. The method of claim 13, wherein the inorganic coordination compound comprises tris(bipyridine)ruthenium(II).

15. A method comprising:
providing a film comprising a substrate and at least one first layer disposed on the substrate, the substrate comprising at least one first surface, the at least one first layer comprising at least a first group of nanowires and a second group of nanowires, the first group of nanowires and the second group of nanowires being substantially aligned with a principle axis substantially normal to the at least one first surface; and
applying at least one stimulus to the at least one second group of nanowires,
wherein after application of the at least one stimulus, the second group of nanowires is aligned at an angle between about 0 degrees and about 90 degrees to the principle axis.

16. The method according to claim 15, wherein the at least one stimulus is directly applied to the at least one second group of nanowires.

17. The method according to claim 15, wherein the at least one stimulus is indirectly applied to the at least one second group of nanowires.

18. The method according to claim 15, further comprising passing a light beam through the at least one first layer to the substrate.

19. The method according to claim 15, wherein the at least one first layer is disposed on the at least one first surface.

20. The method according to claim 19, wherein the film further comprises at least one second layer disposed between the at least one first layer and the at least one first surface.
